(19) United States
(12) Patent Application Publication
(10) Pub. No.: US 2026/0019522 A1
(43) Pub. Date: Jan. 15, 2026

(54) Fax-Transmission Method for Collaboration Platforms

(71) Applicant: Momentum Telecom, Inc, Atlanta, GA (US)

(72) Inventors: Brandon K. BRADLEY, Centennial, CO (US); Rick GARCIA, JR., Sammamish, WA (US); Dmytro KOTELEVSKYI, Lviv Region (UA)

(73) Assignee: Momentum Telecom, Inc, Atlanta, GA (US)

(21) Appl. No.: 19/270,252

(22) Filed: Jul. 15, 2025

Related U.S. Application Data
(60) Provisional application No. 63/671,464, filed on Jul. 15, 2024.

(51) Int. Cl. H04N 1/32; G06F 9/54

(52) U.S. Cl. CPC H04N 1/32539; G06F 9/542; H04N 1/32128

(57) ABSTRACT

A typical embodiment of a fax solution natively integrates the sending, receiving, and storing of faxes into an entity's existing collaboration platform without the need for 3rd party software or web portal access. This fax solution allows users to compose, send, receive, and view faxes from a fax application integrated into a collaboration platform such as, for example, Microsoft Teams. In some embodiments, a fax solution also provides encryption, storage, and automation features for the fax documents, allowing the entity to leverage existing security practices and policies to enhance industry compliance requirements often required for fax transmissions.

### CROSS-REFERENCE TO RELATED APPLICATIONS

This patent application claims the benefit of and incorporates by reference the entire disclosure of U.S. provisional patent application No. 63/671,464, filed on Jul. 16, 2024.

### BACKGROUND

Faxing is a method of sending and receiving documents over a telephone network. Faxing is still widely used in many industries, such as, for example, healthcare, legal, and finance, for transmitting sensitive or confidential information. However, faxing also has some drawbacks, such as requiring dedicated fax machines or lines, consuming paper, and toner, and being vulnerable to interception or tampering.

Collaboration platforms are software applications that enable users to communicate, share, and work together on various tasks and projects. Collaboration platforms such as Microsoft Teams, provide features such as chat, voice and video calls, file sharing, and integration with other applications. Collaboration platforms are becoming more popular and widely adopted in various organizations and industries.

### DESCRIPTION OF ILLUSTRATIVE EMBODIMENTS

The present disclosure relates to a fax solution that integrates sending and receiving of faxes into an entity's collaboration platform. The fax solution may include a fax application that is installed and configured in the collaboration platform, such as Microsoft Teams. The fax application may be configured to allow users to compose, send, receive, and view faxes from within the collaboration platform via use of the collaboration platform's user interface and authentication mechanisms. The fax application may also provide encryption, storage, and automation features for the fax documents.

In a typical embodiment, a fax application communicates with a fax service, provided from Service Provider, to send and receive faxes over a telephone network. The fax application may encrypt the fax documents before sending them to the fax service and decrypts them after receiving them from the fax service. In a typical embodiment, the fax application also stores the fax documents in a remote storage location, such as, for example, SharePoint or OneDrive, that is owned and controlled by the entity. The fax application may also allow the entity to set up single sign-on and permissions for the storage location. In some embodiments, the fax application also enables the automation of fax flows into the entity's systems, such as CRM, ERP, and DLP, by leveraging the collaboration platform's integration capabilities, allowing the entity to control integration from within their existing business automation flows without the need for heavy dependance on the Service Provider.

The following description provides more details and examples of the fax solution that integrates the sending and receiving of faxes into an entity's collaboration platform. The description is based on the use of Microsoft Teams as an example of a collaboration platform, and the Service Provider as an example of a core fax service. However, embodiments of a fax solution are not limited to these examples, and could be implemented with other collaboration platforms and fax services, as well as other features and configurations.

There is a need for a fax solution that can leverage the benefits of collaboration platforms and overcome the drawbacks of traditional faxing. Such a fax solution would enable users to send and receive faxes from within the collaboration platform, without requiring any additional hardware or software. The fax solution would also provide security, storage, and automation features for the fax documents, such as encryption, cloud storage, and integration with other systems.

### Login

In a typical embodiment, a fax solution requires the user to install and grant permissions to the fax application in the collaboration platform. The fax application is usually an enterprise application that is registered and configured by the entity in the collaboration platform. In a typical embodiment, the fax application uses the collaboration platform's authentication mechanisms, such as Microsoft Login Service, to obtain the user's token and access token. The user's token is used to identify the user and the entity in the fax application and associate the user to their assigned fax lines. The access token is used to access the user's information and the entity's resources, such as the remote storage location, through the collaboration platform's APIs, such as Microsoft Graph API.

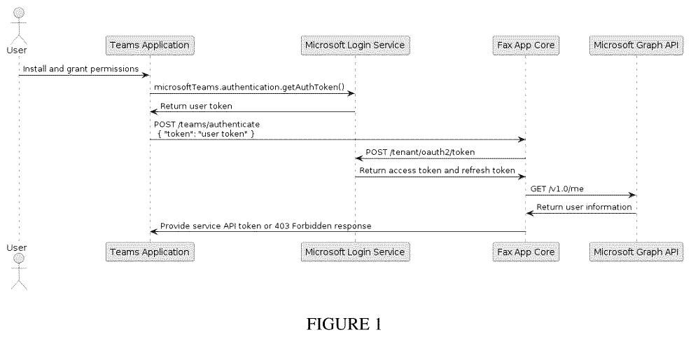

The fax application may also uses the entity's Microsoft Entra ID as an enterprise application that allows the entity to set up single sign-on and permissions for the storage location. The fax application may use the Microsoft Login Service and the Microsoft Graph API to authenticate and authorize the user and the entity, and to obtain and refresh the access token and the refresh token. In a typical embodiment, the fax application stores the tokens in the local database and uses them to access the remote storage location. See FIG. 1.

### Compose a Fax

In a typical embodiment, the fax solution allows the user to compose a fax from within the collaboration platform, using the fax application's user interface. The user can fill a form in the “Compose Fax” section of the fax application, which includes the following fields:
Recipient's Fax Number
Subject
Message
Attachment
Cover Page
Delivery options

The fax application typically validates the user's input and prepares the fax document. The fax document comprises the cover page, the message, and the attachment. The fax application may encrypt the fax document using a strong encryption algorithm, such as AES-256, and a secret key that is generated and stored by the fax application. The fax application may also generate a hash ID from the fax document's message handle, which is a unique identifier provided by the fax service. The hash ID is used to track the status and delivery of the fax document.

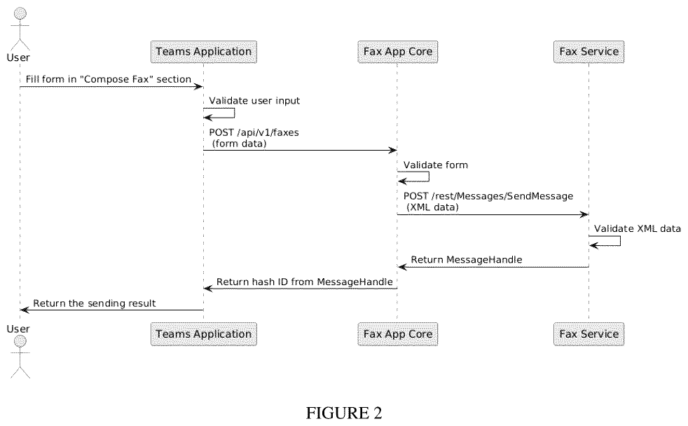

In a typical embodiment, the fax application uses the HTTPS protocol to encrypt the communication between the fax application and the fax service. The fax application uses the strongest HTTPS encryption ciphers, such as TLS_RSA_WITH_AES_256_CBC_SHA256, to ensure the security and integrity of the fax document. The fax application may also uses the hash ID to verify the authenticity of the fax document and the message handle. See FIG. 2.

### Send a Fax

In a typical embodiment, the fax solution allows the user to send a fax from within the collaboration platform, using the fax application's user interface. The user can click a “Send” button in the “Compose Fax” section of the fax application, which may trigger the following actions:
The fax application sends the encrypted fax document and the hash ID to the fax service, using the fax service's API, such as/rest/Messages/SendMessage.
The fax service validates the fax document and the hash ID, and sends the fax document to the recipient's fax number over a telephone network.
The fax service returns a message handle to the fax application, which indicates the status and delivery of the fax document.
The fax application saves the fax document in the customers storage location, such as Sharepoint. The hash ID, and the message handle (CDR) are stored in the local database, and displays them in the “Sent” section of the fax application.
Once Fax Service confirms the fax has successfully sent the fax to the PSTN and stored the Sent Fax document to the storage location, the sent fax queue is purged and the service provider stores no copies of the fax, ensuring the fax data is only stored in the entity's storage location.

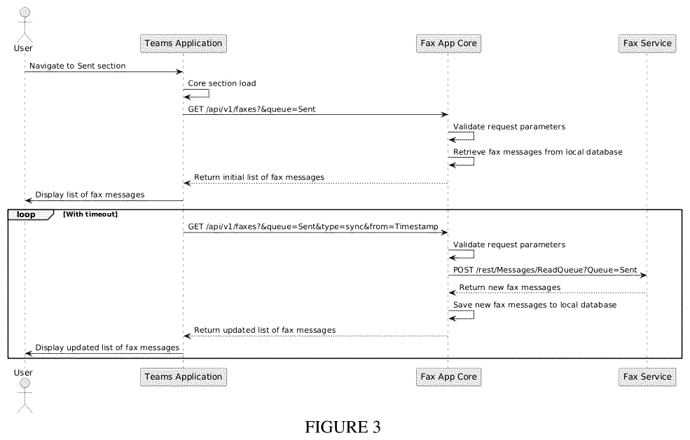

See FIG. 3.

### Receive a Fax

In a typical embodiment, the fax solution allows the user to receive a fax from within the collaboration platform, using the fax application's user interface. The fax solution may use the following mechanisms to receive a fax:
The fax application periodically polls the fax service for new fax messages, using the fax service's API, such as/rest/Messages/ReadQueue. The fax application specifies the queue name, such as “Received”, and the timestamp of the last received fax message, to retrieve only the new fax messages.
The fax service returns the new fax messages to the fax application, which include the encrypted fax documents and the message handles.
The fax application decrypts the fax documents using the secret key, and saves them in the local database, along with the message handles.
The fax application displays the fax documents and the message handles in the “Received” section of the fax application.
Once Fax Service confirms the fax was successfully received the fax from the PSTN and stored the Received fax document to the storage location, the receiving fax queue is purged and the service provider stores no copies of the fax, ensuring the fax data is only stored in the entity's storage location.

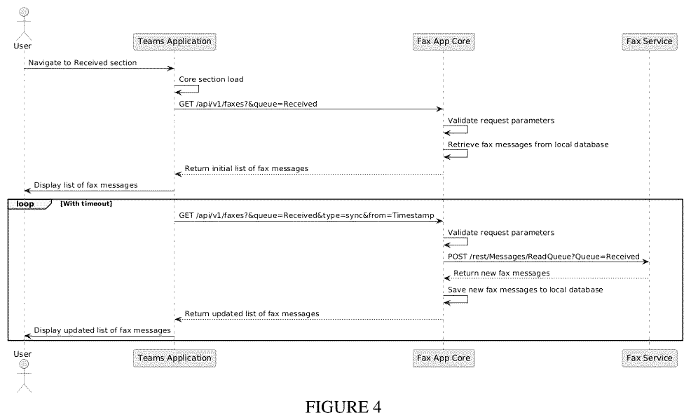

See FIG. 4.

### View a Fax

In a typical embodiment, the fax solution allows the user to view a fax from within the collaboration platform, using the fax application's user interface. The user can navigate to the “Sent” or

“Received” section of the fax application and select a fax message to view. The fax application may perform the following actions:
The fax application checks the organization and user settings, which determine the storage location and encryption options for the fax documents.
Since fax document is stored in a remote storage location owned by the entity, such as SharePoint or OneDrive, the fax application obtains a new access token and refresh token from the Microsoft Login Service, using the previous refresh token. The fax application then retrieves the fax document from the remote storage location, using the Microsoft Graph API.
The fax application returns the PDF response to the collaboration platform, which displays the fax document using a PDF viewer.
The Service Provider does not store a copy of any fax documents. All Fax documents are retrieved form the storage locations as defined by the entity. Fax documents can only be retrieved by user that have been granted access to the Fax application and have existing permissions to view the file within the entity's role based access policies.

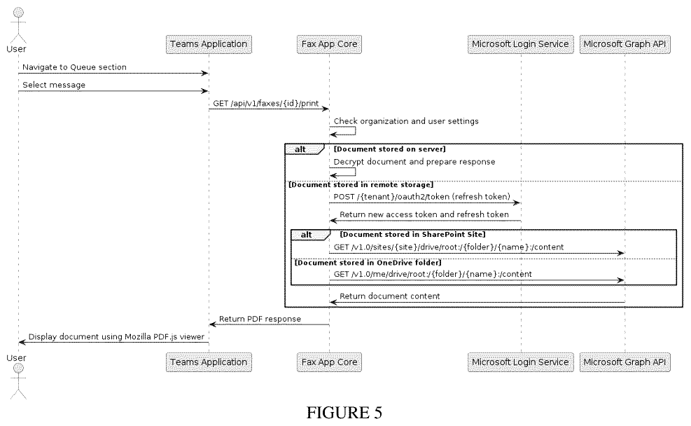

See FIG. 5.

### Store (From Queue) a Fax

In a typical embodiment, the fax solution allows the entity to store a fax in a remote storage location, such as SharePoint or OneDrive, that is owned and controlled by the entity. When a fax is received or when a fax is sent, the application leverages queues to process the faxes. There queues are only used for data in transit. Once the fax has been successfully processed through the queues, the fax documents are stored in the storage location that is defined by the entity. The fax solution may provide the following features for storing a fax:
The fax application allows the entity to set up single sign-on and permissions for the remote storage location, using the collaboration platform's authentication and authorization mechanisms, such as Microsoft Login Service and Microsoft Graph API.
The fax application allows the user to select the remote storage location and the folder name for storing the fax documents, using the fax application's user and admin interfaces.
The Fax storage location, such as Sharepoint or OneDrive, are encrypted by default. The Faxes are stored in the location defined by the entity and as such inherit the existing encryption policies as defined by entity.
The fax application stores the fax documents in the remote storage location, using the Microsoft Graph API, and updates the local database with the storage location and folder name only for purposes of CDR correlation and customer audit and reporting purposes.
Once the fax documents are saved successfully and the processes are completed, the fax service provider purges the queues, ensuring no fax data is saved outside of the entity's storage location.

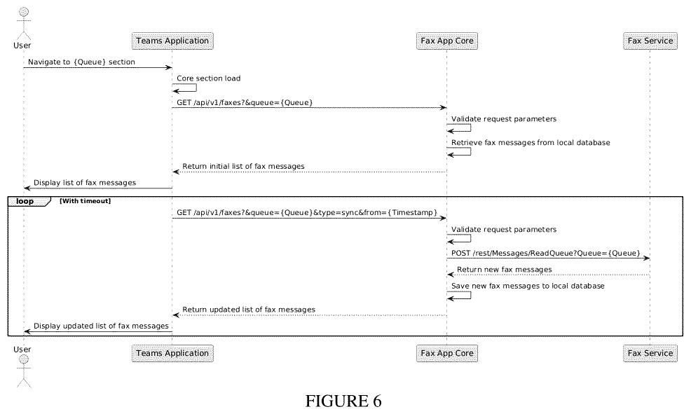

See FIG. 6.

Automate Fax into Existing Business Workflows

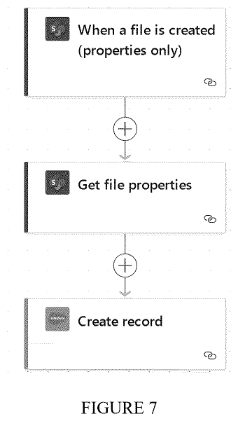

In a typical embodiment, the fax solution allows the entity to automate the fax flows into the entity's systems, such as CRM, ERP, and DLP, using the collaboration platform's native integration capabilities. This eliminates the dependance on the Service Provider for integration needs and allows the entity to use existing integration tools to automate fax flows into their business workflows and security compliance tools. The fax solution may provide the following features for automating a fax:
The fax is stored in the remote storage location, such as Sharepoint and OneDrive. This allows the Entity to use existing automation tools to manipulate the fax flow. For example, the entity can leverage the Microsoft Power Automate platform to automatically transmit the fax into their existing CRM, ERP. See FIG. 7.
Because the fax is stored in the entity's owned storage location, the Entity can easily apply security compliance tools, such as Microsoft Purview, to screen for Data Loss and apply Data Loss Prevention rules. This also allows the entity to apply data classification labels that can then be used to apply compliance around industry requirements, such as HIPAA for healthcare.

What is claimed is:

1. A method of sending a facsimile transmission within a collaboration platform, the method comprising:
a fax application sending an encrypted fax document and a hash ID to a fax service, using a fax service API;
the fax service validating the fax document and the hash ID and sending the fax document to a recipient fax number over a telephone network;
the fax service returning a message handle to the fax application indicating status and delivery of the fax document;
the fax application saving the fax document in a customer storage location, including the hash ID and a message handle; and
purging a sent fax queue.
